(19) United States
(12) Patent Application Publication
(10) Pub. No.: US 2018/0068209 A1
(43) Pub. Date: Mar. 8, 2018

(54) DATA RECORDING MEDIUM AND METHOD OF USING A DATA RECORDING MEDIUM

(71) Applicant: NID SA, La Chaux-de-Fonds (CH)

(72) Inventor: François Droz, Corcelles (CH)

(21) Appl. No.: 15/561,205

(22) PCT Filed: May 13, 2015
(86) PCT No.: PCT/EP2015/060651

§ 371 Date: Sep. 25, 2017

(51) Int. Cl. G06K 19/02; G06K 19/073

(52) U.S. Cl. CPC G06K 19/025; G06K 19/07749; G06K 19/07327

(57) ABSTRACT

The present invention relates to a data recording medium (1) comprising at least one data storage element (7), the data stored in the data storage element (7) being able to be read by a reading device, the medium (1) being produced in such a way that it is transformable so that this data recording medium (1) can become readable by a standardized bank payment card reading device. The present invention also relates to a method of using a data recording medium (1).

### TECHNICAL FIELD OF THE INVENTION

This invention relates to the field of media for recording data which can be read by machines. More specifically, this invention relates to the field of media for recording of data which can be read by standard payment card reading devices. In addition, this invention also relates to a method for using such a data recording medium.

### STATE OF THE ART

Modern life can hardly be imagined anymore without payment cards (for example credit cards or debit cards). Generally, a standard payment card is a card of plastic material, and it is equipped with a magnetic strip and/or electronic chip for storage of data.

The materials, the mechanical properties and the dimensions of the card as well as the positioning of the magnetic strip and of the electronic chip on the card currently form the subject matter of an international standard (called ISO/IEC 7810), aiming to facilitate use of bank payment cards on a global scale. In effect, the object of this standard and of the standardization is to allow the reading of each standardized card by all the electronic readers likewise corresponding to this standard.

As concerns the dimensions in particular, the ISO/IEC 7810 standard specifies that a “regular” payment card (of the “ID-1” type) must measure 85.60×53.98×0.76 (±0.08) mm. For simplicity of use, these same dimensions have also been adopted for a rather large number of other cards (for example, identity cards, driving permits, loyalty cards, visiting cards or business cards, student cards, etc., etc.).

It turns out however that the use of cards with these standardized dimensions is not always optimal. More concretely, the standardized cards are relatively big and rigid and are likely to weigh down the wallet of the user, especially if he has several different cards (which is the case, as a rule, today). It would thus be wise to use cards of reduced dimensions.

Also it would likewise be helpful to be able to use cards with completely different shapes, not at all complying with the current standards, but still able to be used with standardized bank payment card readers.

### SUMMARY OF INVENTION

The object of the present invention is thus to overcome the aforementioned inconveniences and to provide a data recording medium, for example a payment card or an identification card, which can be read by the standardized payment card readers despite the fact that its shape (and/or its dimensions) do not necessarily comply with the standards in force (for example the ISO/IEC 7810 standard).

Another object of the present invention aims to provide a less expensive data recording medium than the similar devices available until today as well as a data recording medium also able to have other functions.

A further object of the present invention aims also to make available a data recording medium whose method of manufacture is simple and economical.

Another object of the present invention, lastly, is also to propose a method of using such a recording medium.

The set objects for the invention are attained with the aid of a data recording medium according to independent claim 1 and with the aid of a method for using a data recording medium according to independent claim 11. Especially preferred embodiments form the subject matter of the dependent claims.

More specifically, the set objects of the invention are attained with the aid of a data recording medium comprising at least one data storage element, the data stored in the data storage element being able to be read by a reading device, which is achieved in such a way that the data recording medium is transformable so as to allow this data recording medium to become readable by a standardized bank payment card reading device.

This reading device can be, for example, a standardized electronic bank payment terminal according to the ISO/IEC 7810 standard.

Preferably, the transformation of the data recording medium according to the present invention includes the modification of its shape and/or its dimensions.

Thanks to such a structure of the data recording medium, it can be used in combination with electronic payment terminals which are nowadays present in a large majority of shops and other establishments in which payments are made, despite having dimensions which can be selected according to needs. Thus it is possible to enlarge the scope of cards thanks to a medium according to the present invention, without losing the advantages of standardization.

In an advantageous embodiment of the present invention, the medium comprises a first element and a second element which can be superimposed one on the other in order to allow the thickness of the medium to correspond approximately to the thickness of a payment card. Thus, it is possible to carry out the transformation of such a medium in a simple and intuitive way. Moreover the data storage elements can be positioned between the two elements in a way so as to be protected against erroneous manipulation or damage before the moment of use.

In a notable way, the first element and the second element are made in one piece and in that, for superimposing the one on the other, they can be folded in an intermediate plane.

Advantageously, a movable flap is provided in the medium. Thanks to use of this flap, the manipulation of the medium can be facilitated, in particular when the latter is of small dimensions. Preferably, this flap can also contain one or more electronic chips which can be used as the chips present on the standardized bank payment cards or, for example, to carry out operations of traceability during the dispatch of labelled products.

It is also conceivable to provide a data recording medium which is designed to be able to be opened out or unfolded. When the data recording medium is of very small dimensions, typically not allowing it to be held to swipe a reading terminal, this variant of the present invention makes it possible to obtain sufficient dimensions (notably the width) so that the medium can be held in a stable and secure way and used in the reading device.

Notably, the medium is at least partially made of polymer, paper or cardboard. The use of polymers is well known in the field of payment cards. The advantages of paper and of cardboard reside in a simpler manufacture and a lower price. Also, the paper and the cardboard lend themselves for the printing of information on the surface of the medium, which facilitates the implementation of an additional function (for example the use of the medium as label for products in the shops).

The data storage element can be a magnetic strip and/or an electronic chip, just like with a standardized payment card.

Also, the medium can comprise fixation means for being attached to an exterior object. This feature likewise facilitates the implementation of alternative or additional applications for the media according to the present invention.

By way of example, the medium according to the present invention can be used instead of a standardized payment card or as a label used to identify a product.

Furthermore, the data recording medium according to one embodiment of the present invention can comprise a bar code and/or a QR code associated with and/or identical to the PAN of the medium. The PAN is an abbreviation of the English term “primary account number” and it is the code used to identify a bank card in an unequivocal way. A PAN generally follows the standardized schema in the ISO/IEC 7812 standard, but other formats and schemas are likewise possible.

Other set objects of the present invention are also attained with the aid of a method for using a data recording medium comprising the following steps in any order:

providing a data recording medium comprising at least one data storage element, the stored data in the data storage element being able to be read by a reading device;

transforming the data recording medium so as to allow this data recording medium to become readable by a reading device for standardized bank payment cards; and

using the transformed data recording medium with the reading device.

Notably, the transformation of the data recording medium can include the modification of its shape and/or of its dimensions. More specifically, the transformation of the data recording medium can include folding and/or cutting.

### BRIEF DESCRIPTION OF THE DRAWINGS

The particularities and the advantages of the present invention will emerge with more details within the context of the detailed description which follows with an embodiment example, given solely by way of illustration and in a non-limiting way, with reference to the attached figures, among which:

FIG. 1 is a schematic view in perspective of an embodiment example of the data recording medium according to the present invention;

FIG. 2 is a perspective view of the data recording medium of FIG. 1 turned over on its other face;

FIG. 3 is a schematic view in perspective of the data recording medium of FIG. 2 in a first stage of preparation for use;

FIG. 4 is a schematic view in perspective of the data recording medium of FIG. 2 in a second stage of preparation for use;

FIG. 5 is a schematic view in perspective of the data recording medium of FIG. 2 in a third stage of preparation for use; and

FIG. 6 is a view from above of the data recording medium of the embodiment example of the data recording medium according to the present invention when it is ready for use.

### DETAILED DESCRIPTION OF THE INVENTION

At the very beginning of this description, we would like to specify that the structurally and functionally identical elements present in the different figures are assigned a single same reference numeral.

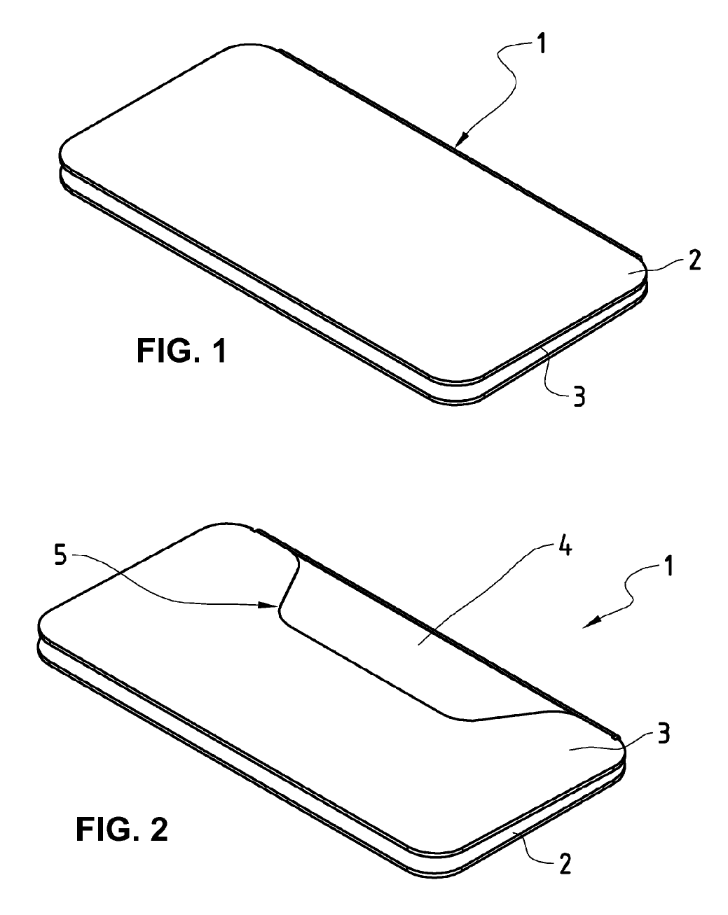

FIG. 1 illustrates an embodiment example of a data recording medium 1 according to the present invention. It is a data recording medium of small dimensions, thus of smaller dimensions than standardized bank payment cards.

The medium 1 according to this embodiment example comprises a first element 2 and a second element 3 of identical dimensions which are positioned one on top of the other. Preferably, the first element 2 and the second element 3 are made in one piece (that is to say as a single piece) and are folded one on the other as can be seen in FIG. 1. Of course it would also be possible to provide a medium 1 in which the first element 2 and the second element 3 are not identical, for example with respect to thickness.

In this position, the first element 2 and the second element 3 can also be fixed one on the other, for example by means of a glue and/or another suitable fixation means, but it is also possible to provide a medium 1 in which the first element 2 and the second element 3 are not fixed one with respect to the other. In any case, the fixation means must be sufficiently “weak” (or breakable) so that the medium 1 can easily be transformed, as will be explained further below.

The first element 1 <sic. 2> and the second element 2 <sic. 3> can be made, for example, of plastic material (a polymer), paper and/or cardboard. Of course other materials are likewise possible. Also, the first element 2 and the second element 3 can be made of a same material, but it is also possible to use different materials.

FIG. 2 illustrates the data recording medium 1 of FIG. 1 when it has been turned over. In fact, the first element 2, which is located above the second element 3 in FIG. 1, is now located beneath the second element 3.

As can be seen in FIG. 2, a flap 4 is provided in the second element 3. A breaking zone 5 (for example perforations) is provided between the flap 4 and the rest of the second element 3. Thanks to this breaking zone 5, the flap 4 can be moved away from the rest of the second element 3, as will be explained later.

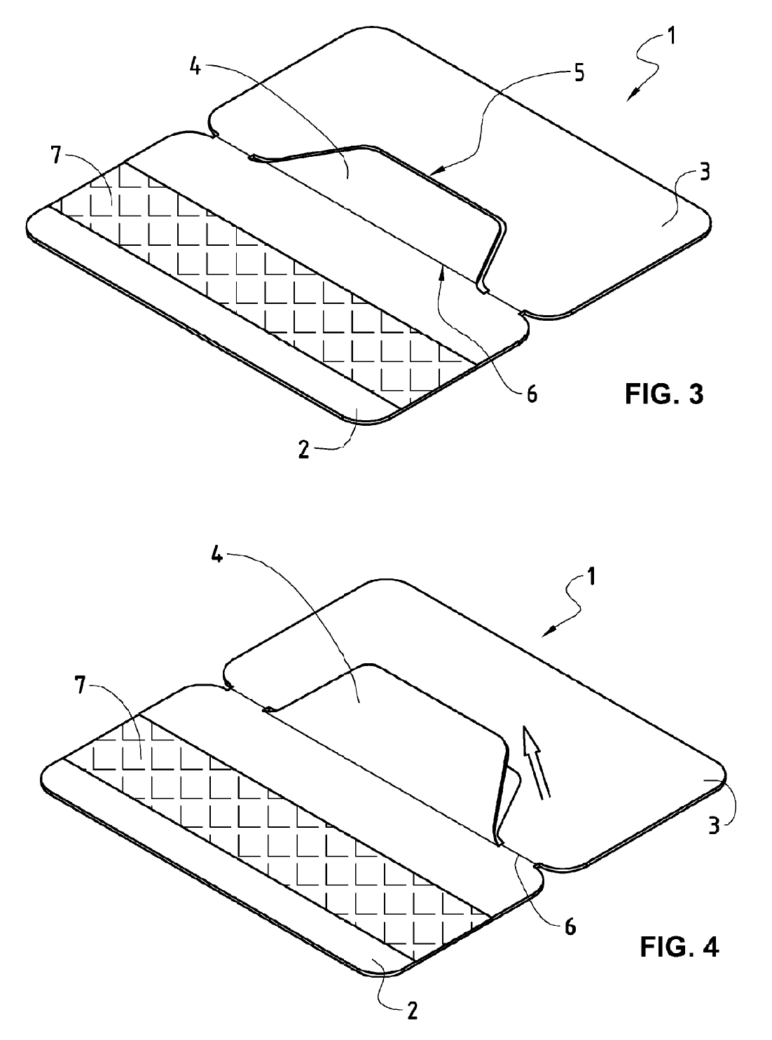

As concerns the recording of data, the medium 1 according to the present invention can comprise either a magnetic strip (illustrated in FIGS. 3 to 6), or an electronic chip (not illustrated), or a combination of a magnetic strip and an electronic chip, like in standard payment cards in particular. Generally, these elements are applied on the faces of the first element 2 and/or of the second element 3 turned toward the interior of the medium 1, in a way so as not to be visible and/or accessible. Such an arrangement has the advantage of better security and protection of data. It is however also conceivable to provide a medium 1 in which the data recording elements are disposed in a visible way.

One or more electronic elements (for example, electronic chips) can also be situated in the flap 4 to allow a tracing or tracking of products.

The reading of the data of the recording elements will also be explained later.

In the form seen in FIGS. 1 and 2, the data recording medium 1 typically does not have standardized dimensions and, even if it comprises the same data recording elements (also using the data recording format entirely or partially) as the standardized payment cards, it generally cannot be read by the standard payment card readers. In order to use the data recording medium 1 in a standard reader, it is thus necessary to adapt it in a suitable way.

To this end, the second element 3 is moved away from the first element 2 so that the first element 2 and the second element 3 come to be positioned in a same plane. This situation is illustrated in FIG. 3. A priori, the first element 2 and the second element 3 remain connected, one to the other, such as is represented by the connection 6. Of course it would be absolutely conceivable to provide a medium 1 in which the first element 2 and the second element 3 are completely separated, one from the other, but it seems wiser to keep these two pieces connected. The connection 6 can also be achieved as a breaking zone, for example also with the aid of perforations. Of course the folding can be done on the small or on the large side of the data recording medium 1.

A magnetic strip 7 is visible in FIG. 3. It is in essence a magnetic strip comparable or identical to magnetic strips which are used in standard payment cards. Also possible would be use of a plurality of magnetic strips (for example, a first one on the first element 2 and a second one on the second element 3), as well as the alternative or cumulative use of one (or more) electronic chips known from standard payment cards.

The magnetic strip 7 (or any other data recording element) can be used for storing of any type of data, depending upon concrete needs of use. For example, if the data recording medium 1 is used instead of a standard payment card, the data stored in the magnetic strip would comprise all the data which are necessary for a smooth flow of financial transactions. A medium 1 used as identification document could store, for its part, all the data necessary to identify a person or an object, for example.

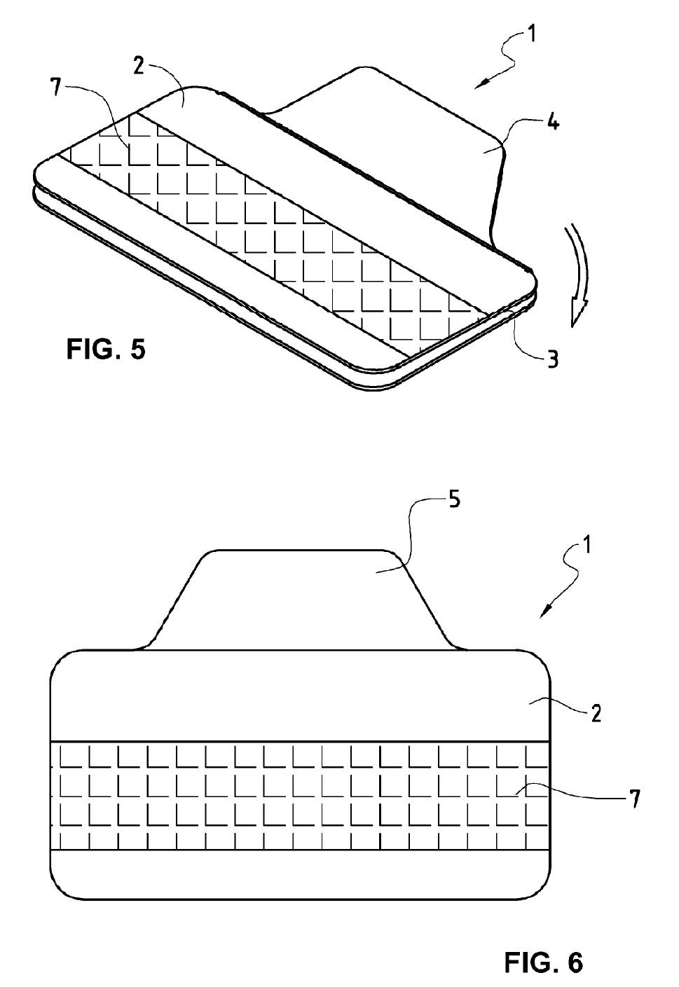

During the next step of preparation for the reading of the medium 1 in the standardized reader, the flap 4 is moved away from the rest of the second element 3 with the aid of the breaking zone 5 which is lifted, as illustrated by the arrow in FIG. 4. Then, as can be seen in FIG. 5, the second element 3 is folded on the other side (in the direction of the arrow) in order to be positioned underneath the first element 2. One thus returns to the initial form of the medium 1, with the exception of the flap 5 <sic. 4> which now protrudes from the medium 1. In addition, the interior faces of the first element 2 and of the second element 3 (thus the faces not visible in FIGS. 1 and 2) are now located on the exterior and thus allow access to the magnetic strip 7.

The medium 1 according to this embodiment example of the present invention is thus ready to be read by a standard payment card reader, as illustrated in FIG. 6. In this form here, the data recording medium 1 can used in an identical way as the standard payment card. That is to say, the flap 4 can be used to take the medium 1 between the fingers and to pass it through the slot in the electronic reading terminal so that the data stored in the magnetic strip can be read by the terminal. When the medium 1 comprises a chip card, it can likewise be read in a way identical to the reading of a standard payment card. Of course it is understood that the flap 4 can also be omitted since it is in effect only necessary for a data recording medium 1 of small dimensions.

At this point it is important to note that the order of the operations which are illustrated in FIGS. 3, 4 and 5 can also be changed without influencing the present invention in a negative way. Also it would likewise be possible to omit separating the flap 5 <sic. 4> from the rest of the second element 3, in particular if the dimensions of the data recording medium 1 are sufficiently big to allow a simple manipulation.

In the form visible in FIGS. 1 and 2, the data recording medium 1 can be used in different ways. It is conceivable, for example, to use the medium 1 with much smaller dimensions compared with the dimensions of a standard payment card (for example a medium measuring 50.00×20.00 mm) made of paper as a label attached to products displayed in the shops. In such a case, the visible surfaces of the first element 2 and/or of the second element 3 could be used for printing the information generally visible on such labels (for example the brand, the price, the size, the serial number, code barre, QR code, etc.). However, it would be also conceivable to use the medium 1 for any other application and to dimension it according to specific needs.

So that the reading of the data recording medium according to the present invention can be achieved in a correct way on all the standardized devices for reading payment cards, it is important to note that the thickness of the medium 1 in the form ready for use corresponds substantially to the values prescribed in the standard or standards in force (for example the standard ISO/IEC 7810). More concretely, in the example illustrated, the thickness of the first element 2 and the thickness of the second element 3 must add up to close to the value of 0.78 <sic. 0.76> (±0.08) mm.

The data recording medium 1 according to the present invention can of course also be folded in three or more parts in order to obtain the desired thickness. As has already been mentioned, a flap for facilitating the passage of the medium 1 into a standardized bank can be present or not, in accordance with the dimensions of the medium 1.

It is clear that this inventive approach allows use of very fine, less heavy and less costly materials with respect to the materials used in a standard way for payment cards.

Of course the present invention is subject to numerous variations as regards its implementation. Although a single embodiment has been described, it is easily comprehensible that it is not feasible to identify in an exhaustive way all the possible embodiments. However, the realization of other equivalent embodiments undoubtedly remains within the purview of one skilled in the art. In this sense, it is of course conceivable to replace one or more described means by one or more equivalent means without departing from the scope of the present invention. Specifically, it would also be possible to provide a data recording medium 1 in accordance with the present invention made up of a single element which, in order to render the medium readable by the standard reading terminals, would have to be folded one or more times until the necessary thickness is attained.

1. Data recording medium comprising at least one data storage element containing stored data, the data stored in the data storage element being able to be read by a reading device, wherein the data recording medium is transformable so as to allow the data recording medium to become readable by a standardized bank payment card reading device.

2. Data recording medium according to claim 1, wherein its transformation includes modification of its shape and/or its dimensions.

3. Data recording medium according to claim 1, wherein the medium comprises a first element and a second element which can be superimposed one on the other in order to allow the thickness of the medium to correspond approximately to the thickness of a standardized bank payment card.

4. Data recording medium according to claim 3, wherein the first element and the second element are made in one piece such that for superimposing the one on the other, they can be folded in an intermediate plane.

5. Data recording medium according to claim 3, wherein the medium comprises a movable flap.

6. Data recording medium according to claim 1, wherein the medium is designed to be able to be opened out or unfolded.

7. Data recording medium according to claim 1, wherein the medium is at least partially made of polymer, paper or cardboard.

8. Data recording medium according to claim 1, wherein the data storage element is a magnetic strip and/or one or more electronic chips.

9. Data recording medium according to claim 8, wherein the one or more electronic chips are fixed on a movable flap of the data recording medium.

10. Data recording medium according to claim 1, comprising a bar code and/or a QR code associated with and/or identical to a PAN (Primary Account Number) of the medium.

11. Data recording medium according to claim 1, wherein the medium comprises fixation means for being attached to an exterior object.

12. Data recording medium according to claim 1, wherein the medium is usable in place of a standardized bank payment card.

13. Data recording medium according to claim 1, wherein the medium is a label used to identify a product.

14. Method for using a data recording medium comprising the following steps in any order:
providing a data recording medium comprising at least one data storage element containing stored data, the stored data in the data storage element being able to be read by a reading device;
transforming the data recording medium so as to allow the data recording medium to become readable by a reading device for standardized bank payment cards; and
reading the transformed data recording medium with the reading device.

15. Method according to claim 14, wherein the transformation of the recording medium includes the modification of its shape and/or its dimensions.

16. Method according to claim 14, wherein the transformation of the data recording medium includes folding and/or cutting.
